(19) United States
(12) Patent Application Publication
(10) Pub. No.: US 2008/0205262 A1
(43) Pub. Date: Aug. 28, 2008

(54) NODE CONTROLLER AND NODE SYSTEM

(76) Inventor: Motoki SUZUKI, Yokohama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 12/022,521

(22) Filed: Jan. 30, 2008

(30) Foreign Application Priority Data
Feb. 23, 2007 (JP) 2007-044033

(51) Int. Cl. G01R 31/08

(52) U.S. Cl. 370/216

(57) ABSTRACT

A communication network including non-GMPLS nodes is treated as a virtual single GMPLS node by a GMPLS integrated controller, in which, when fault recovery is possible within the communication network including the non-GMPLS nodes, the fault recovery is autonomously performed. When fault recovery is unlikely to be achieved within the communication network including the non-GMPLS nodes, GMPLS-based fault recovery process is activated to effectively recover from the fault.

### CLAIM OF PRIORITY

The present application claims priority from Japanese patent application serial no. 2007-044033, filed on Feb. 23, 2007, the content of which is hereby incorporated by reference into this application.

### BACKGROUND OF THE INVENTION

The present invention relates to a node controller and a node system. More particularly, the present invention relates to a node controller and a node system, capable of providing effective fault recovery, when collectively managing plural nodes as a virtual single node, by performing fault recovery within the virtual node.

Recently, inter-node connection control technology has been extensively developed in transmission equipment. GMPLS (Generalized Multiprotocol Label Switching) technology is cited as an example of the inter-node connection control technology that establishes a communication path by a label in a communication network including transmission equipment or other components. The GMPLS technology is described in RFC 3945, which is expected as a method for realizing effective management of networks on which a variety of devices are available, such as a router, time division multiplexer, and OXC (Optical Cross-Connect)/PXC (Photonic Cross-Connect), to meet the needs of diversified services and increased transmission capacity.

GMPLS makes it possible to establish an LSP (Label Switched Path) by a label on a communication network including a packet switch such as a router, a time division switch such as a SONET (Synchronous Optical Network)/SDH (Synchronous Digital Hierarchy) device, and a wavelength or waveband switch such as an OXC/PXC device, based on a group of protocols including a signaling protocol such as GMPLS RSVP-TE (Resource ReserVation Protocol-Traffic Engineering), a routing protocol such as OSPF-TE (Open Shortest Path First-Traffic Engineering), and the like. Incidentally, GMPLS RSVP-TE is described in RFC3473, and OSPF-TE is described in RFC3630.

As a part of the currently existing communication network, there is a monitoring controller such as an NMS (Network Management System) using protocols such as SNMP (Simple Network Management Protocol), TL1 (Transaction Language 1), and CMIP (Common Management Information Protocol), serving as a management device for intensively managing the communication network.

Further, a technology is being developed to consistently establish an LSP to a destination client, involving a core network including SONET/SDH, OXC/PXC and the like, in a source client device using GMPLS and user control protocols such as O-UNI (Optical-User network Interface), OIF-UNI, and GMPLS UNI. Incidentally, OIF-UNI is described in Non-patent document “User Network Interface (UNI) 1.0 Signaling Specification, Release 2”, Feb. 27, 2004, OIF, <http://www.oiforum.com/public/documents/OIF-UNI-01.0-R2-Common.pdf>, and GMPLS UNI is described in RFC4208.

Further, a method is being developed to cope with a problem such as complexity of LSP path computation in MPLS (Multiprotocol Label Switching) and GMPLS, using PCE (Path Computation Element) for path computation purposes. PCE is described in RFC4655.

Still further, the use of technologies such as restoration and protection for fault recovery has been studied from the point of view of reliable communication in GMPLS. The technologies relating to fault recovery in GMPLS are described in RFC4426.

In the GMPLS network using the user control protocols such as O-UNI, OIF-UNI, and GMPLS UNI, a label is secured end to end to consistently manage operations including establishment and deletion of a path as an LSP. Further, in the GMPLS network, the label is secured according to the control protocols between each of the nodes in order to provide inter-node control. Here, the control signal line for inter-node control is not necessarily the same line as a main signal line that conveys user data.

In a case in which a communication network including plural non-GMPLS nodes is managed as a virtual single GMPLS node, the communication network is recognized in GMPLS as a communication network including plural non-GMPLS nodes. Thus, in a case in which a communication network including plural non-GMPLS nodes is managed as a virtual single GMPLS node, when GMPLS-based backup route selection is performed, it has been difficult to select an optimal backup route.

There has been another problem that it takes much time to recover from a fault depending on the result of the backup route selection.

### SUMMARY OF THE INVENTION

The present invention solves the above described problems by treating a communication network including non-GMPLS nodes as a virtual single GMPLS node by a GMPLS integrated controller, and by autonomously performing fault recovery when the fault recovery is possible within the communication network including the non-GMPLS nodes. Hereinafter, a more detailed description will be given.

First, GMPLS-based control is made possible by controlling a communication network including plural non-GMPLS nodes by a GMPLS integrated controller.

Second, when there is an available fault recovery means within the communication network including the non-GMPLS nodes upon LSP establishment, fault recovery is autonomously performed within the communication network including the non-GMPLS nodes.

Third, when a fault occurs within the communication network including the non-GMPLS nodes, a monitoring controller is notified of the occurrence of fault, and then the monitoring controller is notified of the result of fault recovery autonomously performed within the communication network including the non-GMPLS nodes.

Fourth, when an autonomous fault recovery is difficult within the communication network including the non-GMPLS nodes, GMPLS-based fault recovery is performed by issuing GMPLS-based fault notification to the GMPLS network from the GMPLS integrated controller.

By using any of the above described means, at least one of the following objects can be solved.

First, it is possible to effectively control a communication network including plural non-GMPLS nodes by GMPLS in a GMPLS integrated controller that is connected to the communication network including the non-GMPLS nodes.

Second, when a fault occurs within the communication network including the non-GMPLS nodes, it is possible to recover from the fault by autonomously performing fault recovery within the communication network including the non-GMPLS nodes, without performing GMPLS-based fault recovery.

Third, when a fault occurs within the communication network including the non-GMPLS nodes, it is possible for an operator to know the state and cause of the fault, even when fault recovery is autonomously performed within the communication network including the non-GMPLS nodes, by notifying the monitoring controller of the occurrence of fault and then notifying the monitoring controller of the result of the fault recovery autonomously performed within the communication network including the non-GMPLS nodes.

Fourth, when there is no autonomous fault recovery means within the communication network including the non-GMPLS nodes or when the autonomous fault recovery is failed, it is possible to perform GMPLS-based fault recovery by a GMPLS-based fault notification.

### BRIEF DESCRIPTION OF THE DRAWINGS

Preferred embodiments of the present invention will now be descried in conjunction with the accompanying drawings, in which:

FIG. 1 is a block diagram illustrating a configuration of a communication network;

FIG. 2 is a block diagram illustrating a detailed configuration of the communication network;

FIG. 3 is a hardware block diagram of a GMPLS node;

FIG. 4 is a hardware block diagram of a user node;

FIG. 5 is a hardware block diagram of a monitoring controller;

FIG. 6 is a block diagram illustrating a configuration of a GMPLS virtual node;

FIG. 7 is a block diagram illustrating another configuration of the GMPLS virtual node;

FIG. 8 is a hardware block diagram illustrating a non-GMPLS node;

FIG. 9 is a hardware block diagram of a GMPLS integrated controller;

FIG. 10 is a block diagram illustrating a configuration of a communication network using the GMPLS integrated controllers;

FIG. 11 is a diagram illustrating a logical topology recognized by GMPLS;

FIG. 12 is a sequence diagram illustrating an LSP fault recovery policy update process between the monitoring controller and the GMPLS integrated controller;

FIG. 13 is a diagram illustrating an LSP fault recovery policy DB;

FIG. 14 is a sequence diagram of a path establishment process;

FIG. 15 is a sequence diagram illustrating a resource reservation process of the GMPLS virtual node;

FIG. 16 is a sequence diagram illustrating an XC setting process of the GMPLS virtual node;

FIG. 17 is a flowchart illustrating a main signal protection process within the GMPLS virtual node;

FIG. 18 is a diagram illustrating a cross-connect setting state (initial) database stored in the non-GMPLS node 105-7;

FIG. 19 is a diagram illustrating a cross-connect setting state (after resource reservation) database stored in the non-GMPLS node 105-7;

FIG. 20 is a diagram illustrating a cross-connect setting state (after current XC creation) database stored in the non-GMPLS node 105-7;

FIG. 21 is a diagram illustrating a cross-connect setting state (after main signal switching) database stored in the non-GMPLS node 105-7;

FIG. 22 is a diagram illustrating a cross-connect setting state (initial) database stored in the non-GMPLS node 105-9;

FIG. 23 is a diagram illustrating a cross-connect setting state (after resource reservation) database stored in the non-GMPLS node 105-9;

FIG. 24 is a diagram illustrating a cross-connect setting state (after current XC creation) database stored in the non-GMPLS node 105-9;

FIG. 25 is a diagram illustrating a cross-connect setting state (after main signal switching) database stored in the non-GMPLS node 105-9;

FIG. 26 is a diagram illustrating a cross-connect setting state (initial) database stored in the non-GMPLS node 105-8;

FIG. 27 is a diagram illustrating a cross-connect setting state (after resource reservation) database stored in the non-GMPLS node 105-8; and

FIG. 28 is a diagram illustrating a cross-connect setting state (after backup XC creation) database stored in the non-GMPLS node 105-8.

### DESCRIPTION OF THE PREFERRED EMBODIMENTS

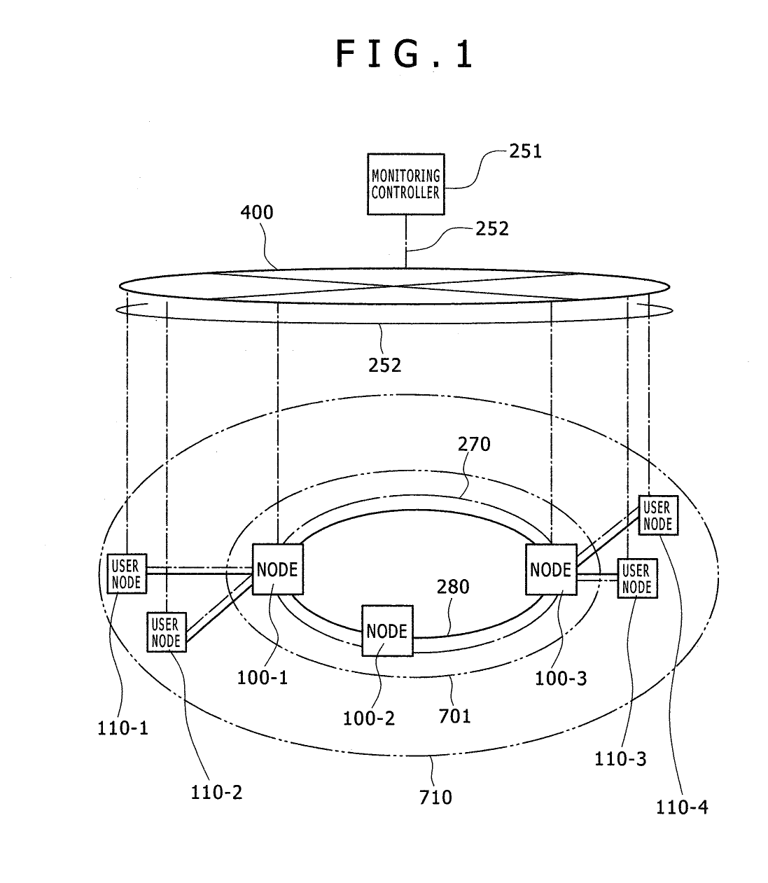

Hereinafter, preferred embodiments of the present invention will be described with reference to the accompanying drawings. Substantially like parts are denoted by like reference numerals and the description will not be repeated. FIG. 1 is a block diagram illustrating a configuration of a communication network. Incidentally, the term “node” is used as a generic term referring to communication equipment such as GMPLS node and user node, unless they need to be differentiated.

In FIG. 1, a communication network 710 has a core network 701 including nodes 100-1 to 100-3 that are selected from a router, Layer 2 Switch, Layer 3 switch, WDM (Wavelength Division Multiplexing), SONET/SDH, or OXC/PXC. The nodes 100 are configured by connecting to user nodes 110-1 to 110-4 that are selected from the router, Layer 2 Switch, Layer 3 switch, WDM, SONET/SDH, or OXC/PXC, through a control channel 270 and a main signal line 280. Incidentally, the control channel 270 can at least make a logical connection between the nodes. Thus, the control channel 270 may use the same line as the main signal line 280, using multiplex systems such as optical wavelength multiplexing and time division multiplexing, or OSC (Optical Supervisory Channel), and the like. It may also be possible to configure using a network other than the main signal line 280. In this case, each of the nodes may be connected through a monitoring control line 252 and a network 400.

The monitoring control line 252 may use wired communication systems such as Ethernet defined in IEEE (Institute of Electrical and Electronic Engineers) 802.3, IEEE802.3z, IEEE802.3ae and the like, ISDN (Integrated Services Digital Network), frame relay network, or any other various private lines, or may use wireless communication systems including wireless LANs (Local Area Networks) defined in IEEE 802.11 and the like.

The nodes 100-1 to 100-3 and the user nodes 110-1 to 110-4 are connected to a monitoring controller 251 through the monitoring control line 252 and the network 400. The monitoring controller 251 performs hardware fault monitoring of the nodes to be connected, transmission quality monitoring of the main signal, and fault detection in the event of a fault occurring in the hardware or in the main signal. Thus, the monitoring controller 251 provides monitoring means to an operator. The monitoring controller 251 also provides control means, such as node setting and path establishment by the operator. Incidentally, there may be plural the monitoring controllers 251 according to necessity. Further, the monitoring control line 252 can at least make a logical connection between the monitoring controller 251 and each of the nodes.

In order to make the logical connection between the nodes and the monitoring controller 251, the monitoring control line 252 may partially use the same line as the main signal line 280 between the nodes by using multiplex systems such as optical wavelength multiplexing and time division multiplexing, or OSC, and the like.

Incidentally, when the control channel 270 between the nodes is connected through the network 400, the same network 400 may be used for the connection between the nodes and the monitoring controller. It may also be possible to build a different network according to necessity. When the same network is used, a different line may be logically configured by VPN (Virtual Private Network), VLAN (Virtual Local Area Network), or other virtual network using protocols such as L2TP (Layer 2 Tunneling Protocol) and GRE (Generic Routing Encapsulation).

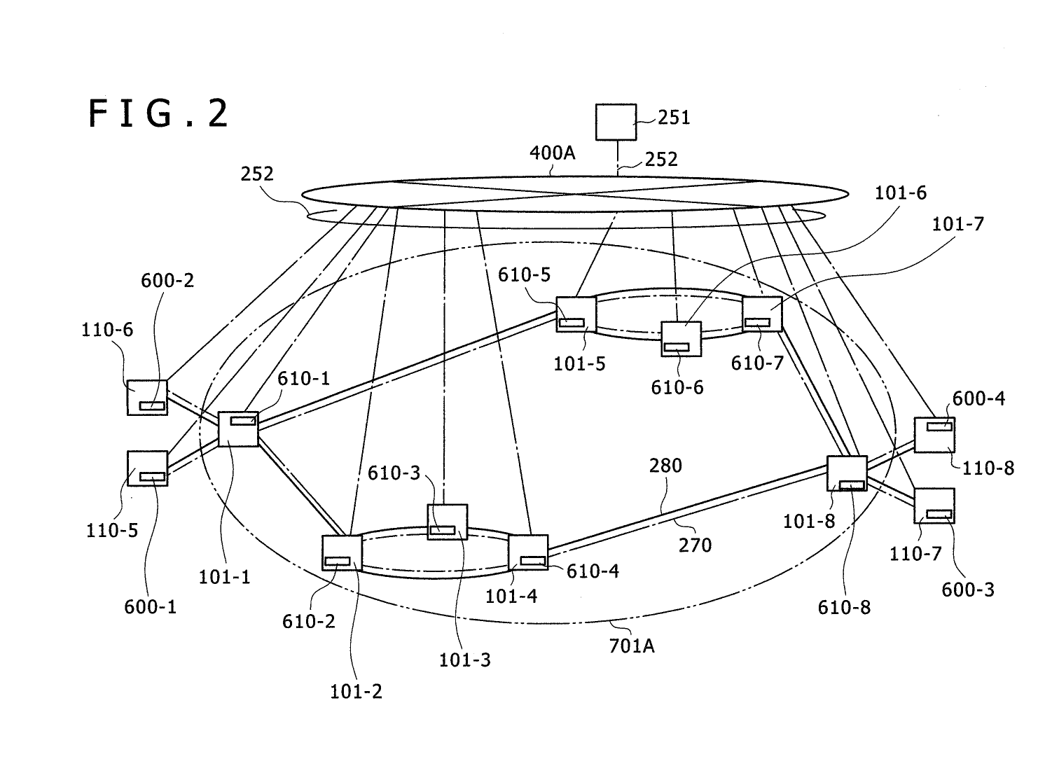

Next, referring to FIG. 2, a description will be given of a detailed configuration of the communication network shown in FIG. 1. Here, FIG. 2 is a block diagram illustrating a detailed configuration of the communication network. In FIG. 2, user nodes 110-5 and 110-6 are connected to user nodes 110-7 and 110-8 through a core network 701A. The user nodes 110-5 to 110-8 may have user control protocols 600-1 to 600-4 as a program, respectively. Examples of the user control protocol may include RSVP-TE, GMPLS-UNI, O-UNI, and OIF-UNI.

The core network 701A includes GMPLS nodes 101-1 to 101-8 having GMPLS 610-1 to 610-8 as a program, respectively. Incidentally, the program may be realized by hardware processing in FPGA (Field Programmable Gate Array), DSP (Digital Signal Processor), network processor, or other type of processor.

The user nodes 110-5 to 110-8 and the GMPLS nodes 101-1 to 101-8 perform communication for inter-node control protocols, such as GMPLS, using the control channel 270. The control channel 270 logically connects each of the nodes. The user nodes 110-5 to 110-8 and the GMPLS nodes 101-1 to 101-8 are further connected to the monitoring controller 251 through the monitoring control line 252.

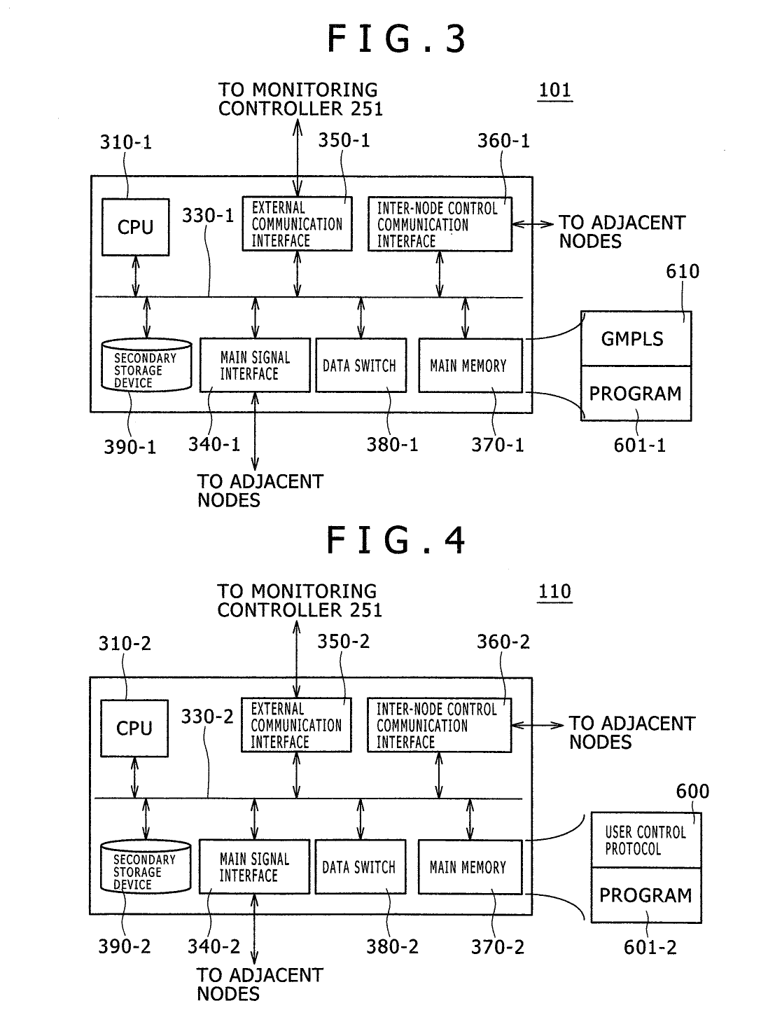

Referring to FIG. 3, a description will be given of a hardware configuration of the GMPLS node. Here, FIG. 3 is a hardware block diagram of the GMPLS node. In FIG. 3, the GMPLS node 101 includes a central processing unit (CPU) 310-1, an internal communication line 330-1 such as a bus, an external communication interface 350-1, an inter-node control communication interface 360-1, a secondary storage device 390-1, a main signal interface 340-1, a data switch 380-1, and a main memory 370-1.

The main memory 370-1 is a rewritable semiconductor memory such as RAM (Random Access Memory), storing a program 601-1 and a GMPLS protocol 610 that are executed by the central processing unit (CPU) 310-1. The program 601-1 performs processes such as decoding and execution of control instructions received in the GMPLS node 101 from the monitoring controller 251, hardware fault monitoring within the GMPLS node 101, and monitoring and control of the GMPLS node 101 according to the content set by the monitoring controller 251.

The secondary storage device 390-1 includes a rewritable nonvolatile semiconductor memory, a hard disk, and the like. Examples of the rewritable nonvolatile semiconductor memory are Flash ROM (Read Only Memory), Compact Flash, SSFDC (Solid State Floppy (registered trade mark) Disk Card), and SD memory card (Secure Digital memory card). The secondary storage device 390-1 operates as a memory area of the software such as the program 601-1 and the GMPLS protocol 610. Further, the secondary storage device may also store data and logs generated by program execution. When storing data such as MAC address (Media Access Control Address) not requiring updating, or when storing a program requiring less frequent updating, the secondary storage device 390-1 may be configured using a nonvolatile ROM such as EPROM (Erasable Programmable Read Only Memory) or EEPROM (Electronically Erasable and Programmable Read Only Memory).

There may be plural the main signal interfaces 340-1 according to necessity. The main signal interface 340-1 may include signaling systems such as Ethernet defined in IEEE802.3, IEEE802.3z, IEEE802.3ae and the like, or SONET/SDH defined in “International Telecommunication Union Telecommunication Standardization sector” (ITU-T) G.707, G.783 and the like, or OTN (Optical Transport Network) defined in ITU-T G.709 and the like, according to necessity. The main signal interface 340-1 is connected to the other adjacent node and is used for exchanging user data. The data switch 380-1 is selected from an electric switch, an optical switch of MEMS (Micro Electro Mechanical System) type or of PLC (Planar Lightwave Circuit) type, a time division multiplexing switch, and an ADD/DROP switch, or other switches. The data switch 380-1 performs switching and connection of the main signal.

The inter-node control communication interface 360-1 is connected to the other adjacent node, and provides communication for inter-node control. The GMPLS node exchanges control signals such as the routing protocol, signaling protocol, and user control protocol through the inter-node control communication interface 360-1. Incidentally, the inter-node control communication interface 360-1 used here may be the same interface as the main signal interface 340-1 according to the GMPLS specifications.

The external communication interface 350-1 is logically connected to the monitoring controller 251. The external communication interface 350-1 exchanges event notifications to the monitoring controller 251 as well as control signals from the monitoring controller 251, using protocols such as SNMP, TL1, and HDLC (High-level Data Link Control procedure). The program 601-1 on the main memory 370-1 may execute other processes than those described above according to necessity. Further, the external communication interface 350-1 may also serve as the inter-node control communication interface 360-1.

Referring to FIG. 4, a description will be given of a hardware configuration of the user node. Here, FIG. 4 is a hardware block diagram of the user node. In FIG. 4, the user node 110 includes a central processing unit (CPU) 310-2, an internal communication line 330-2 such as a bus, an external communication interface 350-2, an inter-node control communication interface 360-2, a secondary storage device 390-2, a main signal interface 340-2, a data switch 380-2, and a main memory 370-2.

The main memory 370-2 is a rewritable semiconductor memory such as RAM, storing a program 601-2 and a user control protocol 600 that are executed by the central processing unit (CPU) 310-2. The program 601-2 performs processes such as decoding and execution of control instructions received in the user node 110 from the monitoring controller 251, hardware fault monitoring within the user node 110, and monitoring and control of the user node 110 according to the content set by the monitoring controller 251.

The secondary storage device 390-2 includes a rewritable nonvolatile semiconductor memory, a hard disk, and the like. Examples of the rewritable nonvolatile semiconductor memory are Flash ROM, Compact Flash, SSFDC, and SD memory card. The secondary storage device 390-2 operates as a memory area of the software such as the program 601-2 and the user control protocol 600. Further, the secondary storage device 390-2 may also store data and logs generated by program execution. When storing data such as MAC address not requiring updating, or when storing a program requiring less frequent updating, the secondary storage device 390-2 may be configured using a nonvolatile ROM such as EPROM or EEPROM.

There may be plural the main signal interfaces 340-2 according to necessity. The main signal interface 340-2 may include signaling systems such as Ethernet defined in IEEE802.3, IEEE802.3z, IEEE802.3ae and the like, or SONET/SDH defined in ITU-T G.707, G.783 and the like, or OTN defined in ITU-T G.709 and the like, according to necessity. The main signal interface 340-2 is connected to the other adjacent node and is used for exchanging user data. The data switch 380-2 is selected from an electric switch, an optical switch of MEMS type or of PLC type, a time division multiplexing switch, an ADD/DROP switch, or other switches. The data switch 380-2 performs switching and connection of the main signal.

The inter-node control communication interface 360-2 is connected to the other adjacent node, and provides communication for inter-node control. The user node 110 exchanges control signals such as the routing protocol, signaling protocol, and user control protocol through the inter-node control communication interface 360-2. The inter-node control communication interface 360-2 used here may be the same interface as the main signal interface 340-2 according to the GMPLS specifications.

The external communication interface 350-2 is logically connected to the monitoring controller 251. The external communication interface 350-2 exchanges event notifications to the monitoring controller 251 as well as control signals from the monitoring controller 251, using the protocols such as SNMP, TL1, and HDLC. The program 601-2 on the main memory 370-2 may execute other processes than those described above according to necessity. Further, the external communication interface 350-2 may also serve as the inter-node control communication interface 360-2.

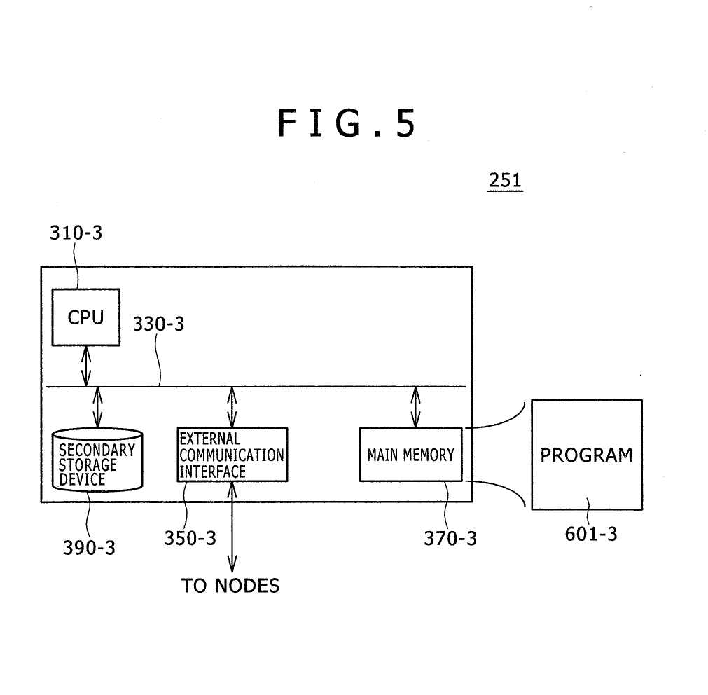

Referring to FIG. 5, a description will be given of a hardware configuration of the monitoring controller. Here, FIG. 5 is a hardware block diagram of the monitoring controller. In FIG. 5, the monitoring controller 251 includes a central processing unit (CPU) 310-3, an internal communication line 330-3 such as a bus, an external communication interface 350-3, a secondary storage device 390-3, and a main memory 370-3.

The main memory 370-3 is a rewritable semiconductor memory such as RAM, storing a program 601-3 executed by the central processing unit (CPU) 310-3. The program 601-3 performs processes such as decoding and execution of control instructions input by the operator, hardware fault monitoring of the monitoring controller 251, and monitoring and control of the nodes according to the content set by the operator.

The secondary storage device 390-3 includes a rewritable nonvolatile semiconductor memory, a hard disk, and the like. Examples of the rewritable nonvolatile semiconductor memory are Flash ROM, Compact Flash, SSFDC, and SD memory card. The secondary storage device 390-3 operates as a memory area of the software such as the program 601-3. Further, the secondary storage device 390-3 may also store data and logs generated by program execution. When storing data such as MAC address not requiring updating, or when storing a program requiring less frequent updating, the secondary storage device 390-3 may be configured using a nonvolatile ROM such as EPROM or EEPROM.

The external communication interface 350-3 is logically connected to the nodes. The external communication interface 350-3 exchanges event notifications from the nodes as well as control signals to the nodes, using the protocols such as SNMP, TL1, HDLC. Incidentally, the program 601-3 on the main memory 370-3 may execute other processes than those described above according to necessity. Further, the throughput of the monitoring controller 251 may be increased with a clustering method or other methods.

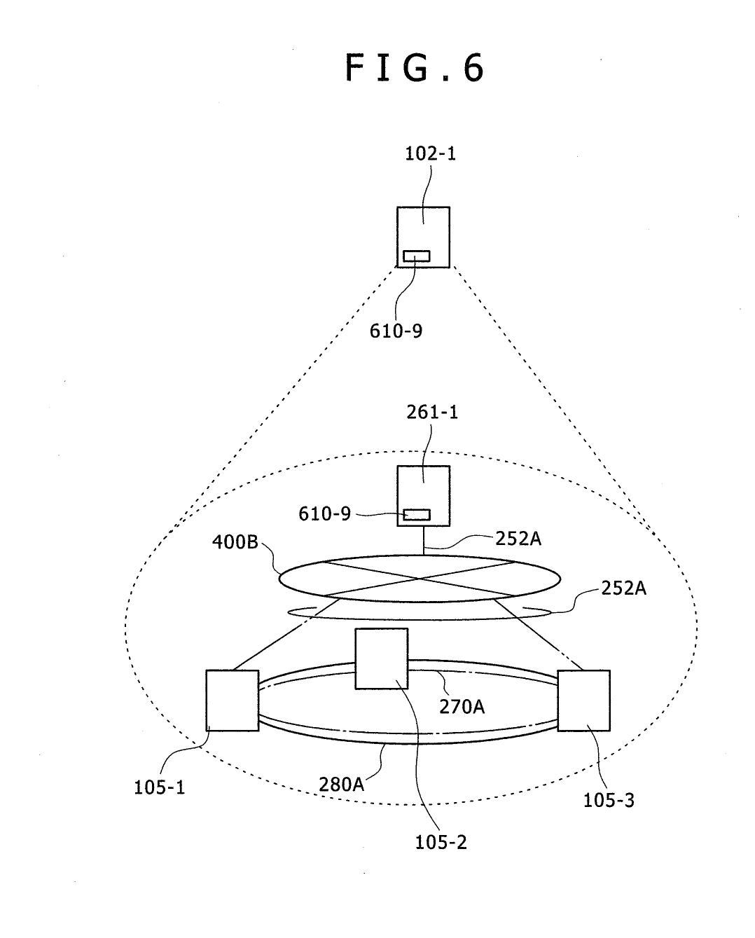

Referring to FIG. 6, a description will be given of a configuration in which a communication network including plural non-GMPLS nodes is managed as a GMPLS virtual node by a GMPLS integrated controller. Here, FIG. 6 is a block diagram illustrating a configuration of the GMPLS virtual node. In FIG. 6, the non-GMPLS nodes 105-1 to 105-3 are connected by a main signal line 280A. Further, the non-GMPLS nodes 105-1 to 105-3 are connected by a control channel 270A to provide communication for monitoring control. The control channel 270A can at least make a logical connection. Thus, the control channel 270A may use the same line as the main signal line 280A, using multiplex systems such as optical wavelength multiplexing and time division multiplexing, or OSC, and the like. Further, the non-GMPLS nodes 105-1 to 105-3 are connected to a GMPLS integrated controller 261-1 through a network 400B by a monitoring control line 252A.

The monitoring control line 252A may use wired communication systems such as Ethernet defined in IEEE802.3, IEEE802.3z, and IEEE802.3ae and the like, ISDN, frame relay network, or any other various private lines, or may use wireless communication systems including wireless LANs defined in IEEE 802.11, and the like.

The GMPLS integrated controller 261-1 includes a GMPLS 610-9 as a program, and provides control to the non-GMPLS nodes 105-1 to 105-3. Incidentally, the control to the non-GMPLS node 105-2 is realized through the non-GMPLS node 105-1 or 105-3 and then through the control channel 270A.

As described above, it makes it possible for the GMPLS to recognize and control the communication network including the non-GMPLS nodes 105-1 to 105-3 as a GMPLS virtual node 102-1. Incidentally, the non-GMPLS nodes may also be connected to the monitoring controller 251 not shown. There may be plural the GMPLS integrated controllers 261 according to necessity.

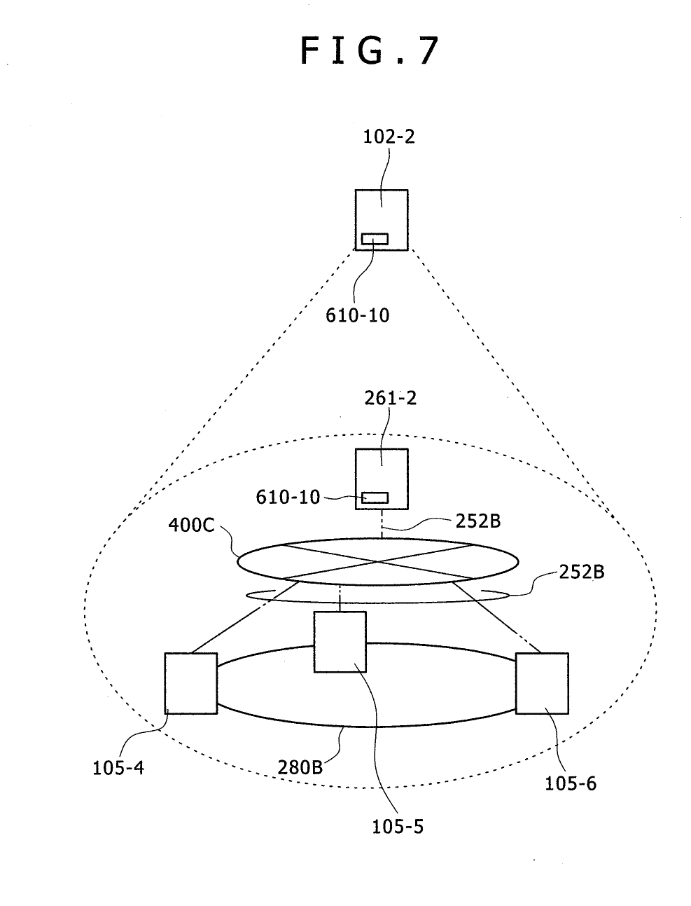

Referring to FIG. 7, a description will be given of another configuration in which a communication network including plural non-GMPLS nodes is managed as a GMPLS virtual node by a GMPLS integrated controller. Here, FIG. 7 is a block diagram illustrating another configuration of the GMPLS virtual node. In FIG. 7, non-GMPLS nodes 105-4 to 105-6 are connected by a main signal line 280B. Further, the non-GMPLS nodes 105-4 to 105-6 are connected to a GMPLS integrated controller 261-2 through a network 400C by a monitoring control line 252B. The monitoring control line 252B may use wired communication systems such as Ethernet defined in IEEE802.3, IEEE802.3z, IEEE802.3ae and the like, ISDN, frame relay network, or other various private lines, or wireless communication systems using wireless LANs using IEEE 802.11, and the like.

The GMPLS integrated controller 261-2 includes a GMPLS 610-10 as a program, and provides control to the non-GMPLS nodes 105-4 to 105-6.

As described above, it is possible for the GMPLS to recognize and control the communication network including the non-GMPLS nodes 105-4 to 105-6 as a GMPLS virtual node 102-2. Incidentally, the non-GMPLS nodes 105-4 to 105-6 may also be connected to the monitoring controller 251 not shown. There may be plural the GMPLS integrated controllers 261 according to necessity.

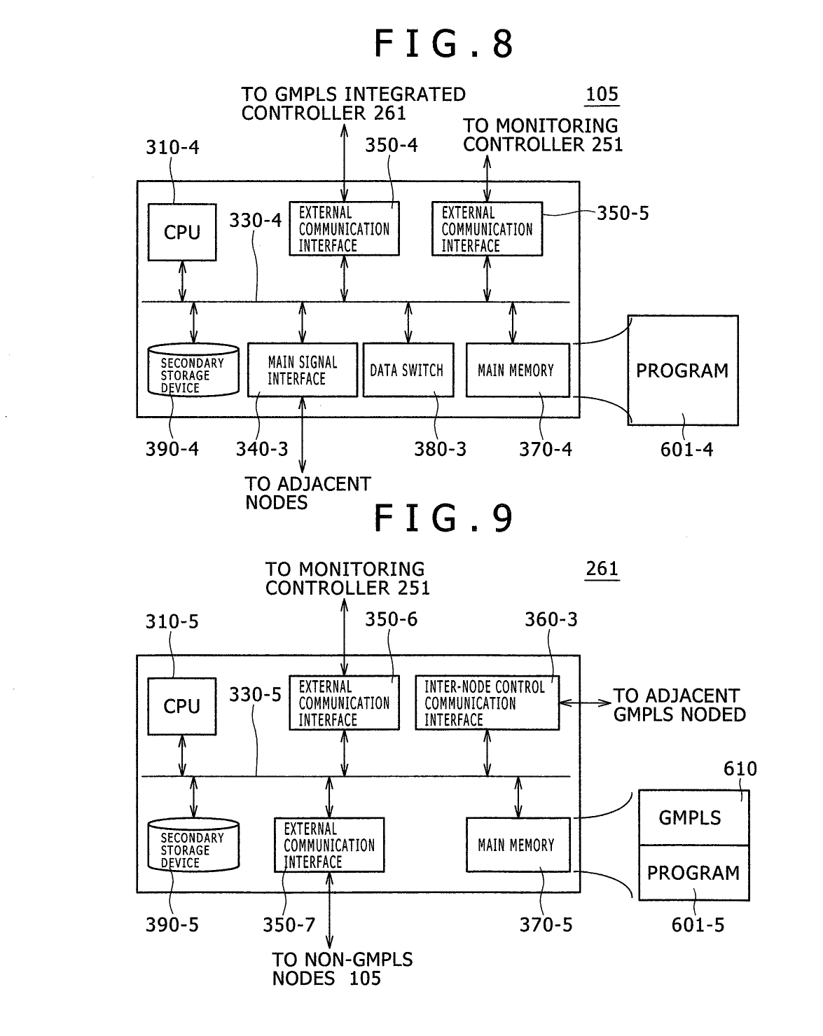

Referring to FIG. 8, a description will be given of a hardware configuration of the non-GMPLS node. Here, FIG. 8 is a hardware block diagram illustrating the non-GMPLS node. In FIG. 8, the non-GMPLS node 105 includes a central processing unit (CPU) 310-4, an internal communication line 330-4 such as a bus, external communication interfaces 350-4 and 350-5, a secondary storage device 390-4, a main signal interface 340-3, a data switch 380-3, and a main memory 370-4. The main memory 370-4 is a rewritable semiconductor memory such as RAM, storing a program 601-4 executed by the central processing unit (CPU) 310-4.

The program 601-4 performs processes such as decoding and execution of control instructions received in the non-GMPLS node 105 from the monitoring controller 251, hardware fault monitoring of the GMPLS node 105, and monitoring and control of the non-GMPLS node 105 according to the content set by the monitoring controller 251. The secondary storage device 390-4 includes a rewritable nonvolatile semiconductor memory, a hard disk, and the like. Examples of the rewritable nonvolatile semiconductor memory are Flash ROM, Compact Flash, SSFDC, and SD memory card. The secondary storage device 390-4 operates as a memory area of the software such as the program 601-4. Further, the secondary storage device 390-4 may also store data and logs generated by program execution. When storing data such as MAC address not requiring updating, or when storing a program requiring less frequent updating, the secondary storage device 390-4 may be configured using a nonvolatile ROM such as EPROM or EEPROM.

There may be plural the main signal interfaces 340-3 according to necessity. The main signal interface 340-3 may include signaling systems such as Ethernet defined in IEEE802.3, IEEE802.3z, IEEE802.3ae and the like, SONET/SDH defined in ITU-T G.707, G.783 and the like, or OTN defined in ITU-T G.709 and the like. The main signal interface 340-3 is connected to the other adjacent node, and is used for exchanging user data. The data switch 380-3 is selected from an electric switch, an optical switch of MEMS type or of PLC type, a time division multiplexing switch, and an ADD/DROP switch. The data switch 380-3 performs switching and connection of the main signal.

The external communication interface 350-4 is logically connected to the GMPLS integrated controller 261. The external communication interface 350-5 is logically connected to the monitoring controller 251. The external communication interfaces 350-4 and 350-5 use the protocols such as SNMP, TL1, and HDLC. The external communication interface 350-4 exchanges control signals from the GMPLS integrated controller 261. The external communication interface 350-5 exchanges event notifications to the monitoring controller 251 as well as control signals from the monitor controller 251. For example, when the control signal from the monitoring controller 251 is realized through the GMPLS integrated controller 261, the external communication interface 350-5 may be omitted. The external interfaces 350-4 and 350-5 may be the same interface depending on the configuration. Incidentally, the program 601-4 on the main memory 370-4 may execute other processes than those described above according to necessity.

Referring to FIG. 9, a description will be given of a hardware configuration of the GMPLS integrated controller. Here, FIG. 9 is a hardware block diagram of the GMPLS integrated controller. In FIG. 9, the GMPLS integrated controller 261 includes a central processing unit (CPU) 310-5, an internal communication line 330-5 such as a bus, an external communication interfaces 350-6 and 350-7, an inter-node control communication interface 360-3, a secondary storage device 390-5, and a main memory 370-5. The main memory 370-5 is a rewritable semiconductor memory such as RAM, storing a program 601-5 and GMPLS protocol 610 that are executed by the central processing unit (CPU) 310-5. The program 601-5 performs processes such as decoding and execution of control signals received in the GMPLS integrated controller 261 from the monitoring controller 251, hardware fault monitoring of the GMPLS integrated controller 261, monitoring and control of the GMPLS integrated controller 261 according to the content set by the monitoring controller 251, and monitoring and control of the non-GMPLS nodes 105 controlled by GMPLS integrated controller 261.

The inter-node control communication interface 360-3 is connected to the other adjacent node, and provides communication for inter-node control. The GMPLS integrated controller 261 exchanges control signals such as the routing protocol, signaling protocol, and user control protocol, with the adjacent GMPLS node through the inter-node control communication interface 360-3.

The secondary storage device 390-5 includes a rewritable nonvolatile semiconductor memory, a hard disk, and the like. Examples of the rewritable nonvolatile semiconductor memory are Flash ROM, Compact Flash, SSFDC, and SD memory card. The secondary storage device 390-5 operates as a memory area of the software such as the program 601-5 and the GMPLS protocol 610. Further, the secondary storage device 390-5 may also store data and logs generated by program execution. When storing data such as MAC address not requiring updating, or when storing a program requiring less frequent updating, the secondary storage device 390-5 may be configured using a nonvolatile ROM such as EPROM or EEPROM.

The external communication interface 350-7 is logically connected to the non-GMPLS nodes 105. The external communication interface 350-6 is logically connected to the monitoring controller 251. The external communication interfaces 350-6 and 350-7 use the protocols such as SNMP, TL1, and HDLC. The external communication interface 350-7 exchanges GMPLS-based control signals to the non-GMPLS nodes 105. The external communication interface 350-6 exchanges event notifications from the nodes to the monitoring controller 251, as well as control signals to the nodes. Incidentally, the program 601-5 on the main memory 370-5 may execute other processes than those described above according to necessity. For example, when the control signal from the monitoring controller 251 is realized through the non-GMPLS nodes 105, the external communication interface 350-6 may be omitted. The external communication interfaces 350-6 and 350-7 may be the same interface depending on the configuration. Further, the external communication interfaces 350-6 and 350-7 may also serve as the inter-node control communication interface 360-3. Further, the throughput of the GMPLS integrated controller 261 may be increased with a clustering method or other methods.

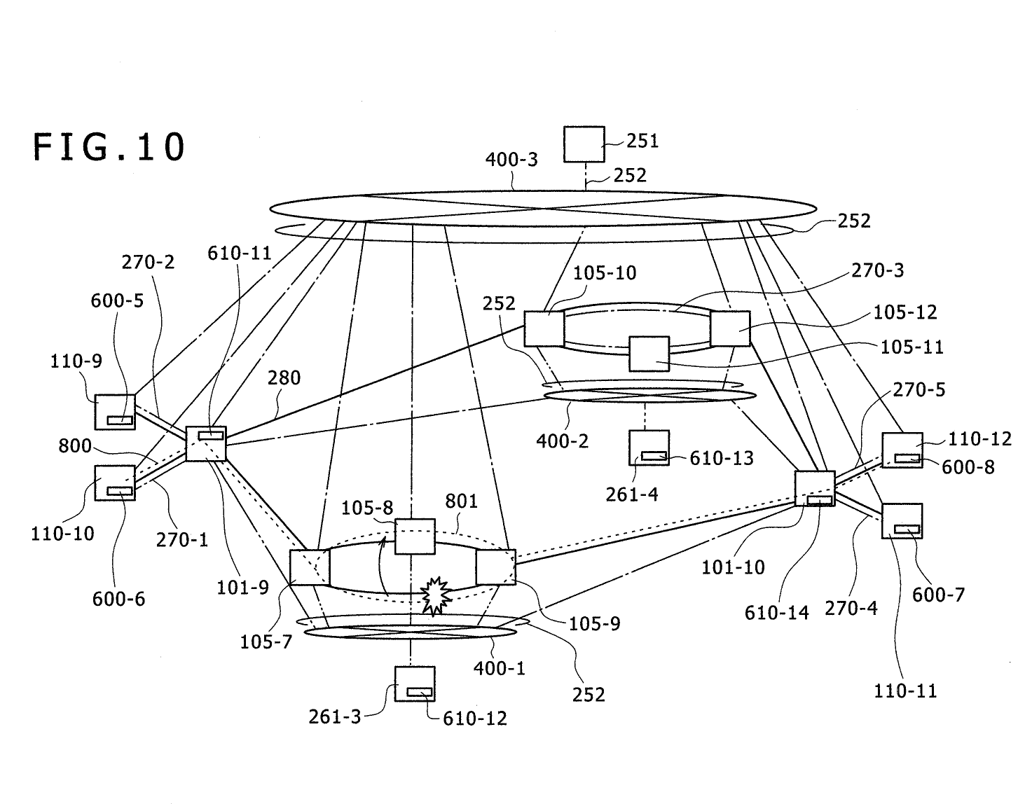

Referring to FIG. 10, a description will be given of a configuration of a communication network using GMPLS integrated controllers. Here, FIG. 10 is a block diagram illustrating a configuration of a communication network using GMPLS integrated controllers. In FIG. 10, a core network is formed by GMPLS integrated controllers 261-3 and 261-4. The GMPLS integrated controller 261-3 is capable of GMPLS-based control by integrally controlling a GMPLS node 101-9 having a GMPLS 610-11, a GMPLS node 101-10 having a GMPLS 610-14, and non-GMPLS nodes 105-7 to 105-9. The GMPLS integrated controller 261-4 is capable of GMPLS-based control by integrally controlling non-GMPLS nodes 105-10 to 105-12. The GMPLS node 101-9 is connected to the GMPLS integrated controllers 261-3 and 261-4 by the monitoring control line 252 through the network 400-1 or 400-2. The GMPLS node 101-10 is connected to the GMPLS integrated controllers 261-3 and 261-4 by the monitoring control line 252 through the network 400-1 or 400-2.

The GMPLS node 101-9 is connected to user nodes 110-9 and 110-10, exchanging control instructions relating to the inter-node autonomous control protocol, and the like, through control channels 270-1 and 270-2. The GMPLS node 101-10 is connected to user nodes 110-11 and 110-12, exchanging control instructions relating to the inter-node autonomous control protocol, and the like, through control channels 270-4 and 270-5.

Each of the nodes is connected to the monitoring controller 251 through the monitoring control line 252, the network 400-3, and the control channel 270-3. Incidentally, in FIG. 10, the GMPLS integrated controller 261 is connected to the monitoring controller 251 through the non-GMPLS nodes 105.

A path 800, indicated by a dotted line, is established in a state through the user node 110-10, GMPLS node 101-9, non-GMPLS nodes 105-7 and 105-9, GMPLS node 110-10, and user node 110-12, using the inter-node autonomous protocol by the GMPLS integrated controller 261-3. Further, a partial backup path 801 is reserved or established between the non-GMPLS nodes 105-7, 105-8, and 105-9. In the path 800, when a fault occurs between the non-GMPLS nodes 105-7 and 105-9, fault recovery is performed by switching to the partial backup path 801 instead of GMPLS-based fault recovery. In this way, it is possible to avoid unnecessary resource consumption. Incidentally, the monitoring controller 251 may be notified of the information on the fault, such as the location and cause of the fault, as an event.

Incidentally, it is possible to suppress GMPLS-based fault recovery upon detection of a fault in the GMPLS nodes 101-9 and 101-10, by warning transfer of the main signal. More specifically, it is possible to set a condition so that GMPLS-based fault recovery is not activated in the GMPLS nodes 101-9 and 101-10 by warning transfer of the main signal. Upon detection of a fault due to interruption of the main signal between the GMPLS node 101-9 and the non-GMPLS node 105-7 or between the non-GMPLS node 105-9 and the GMPLS node 101-10, the condition is set so as to perform GMPLS-based fault recovery. Also, when an interruption of the main signal occurs within the GMPLS virtual node 102 including the non-GMPLS nodes 105-7 to 105-9, the path is switched in the main signal interface 340-1 of the GMPLS node 101 shown in FIG. 3 and in the main signal interface 340-3 of the non-GMPLS node 105 shown in FIG. 8, thereby to continue to transmit the main signal and to transfer warning information together with the main signal information. In this way, it is possible for the GMPLS nodes 101-9 and 101-10 to determine the main signal interruption that has occurred within the GMPLS virtual node 102 including the non-GMPLS nodes 105-7 to 105-9. When the GMPLS nodes 101-9 and 101-10 determine that the main signal interruption has occurred within the GMPLS virtual node 102 including the non-GMPLS nodes 105-7 to 105-9, the program 601-1 shown in FIG. 3 is set so as not to perform GMPLS-based fault recovery in the GMPLS nodes 101-9 and 101-10.

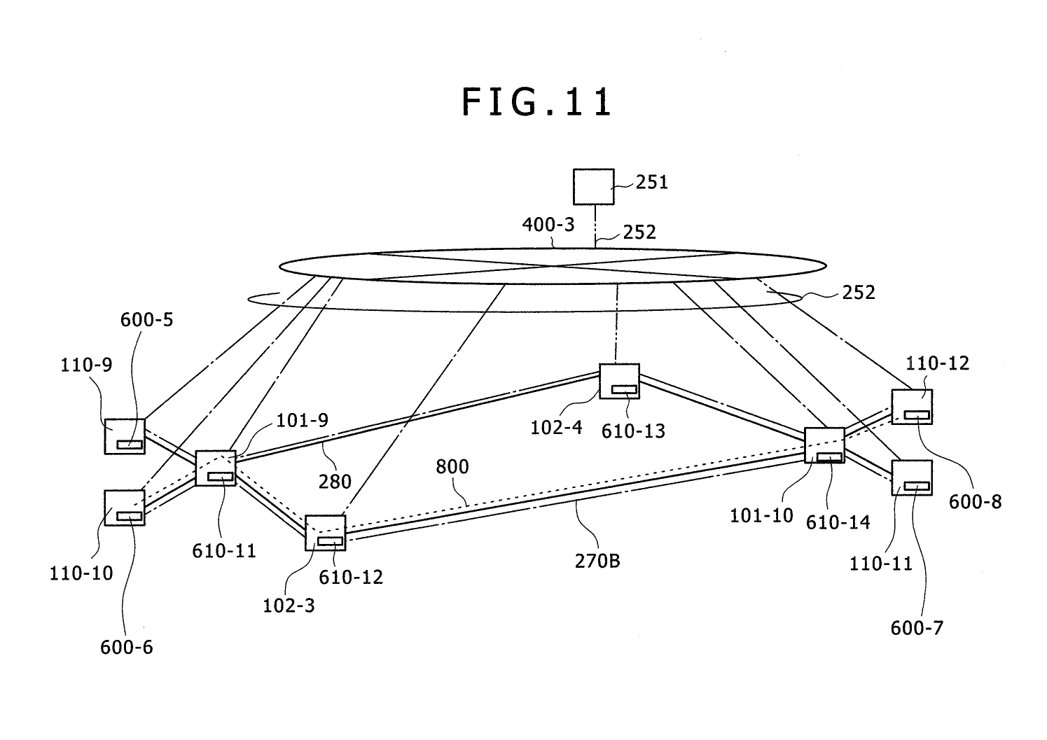

Referring to FIG. 11, a description will be given of a logical topology recognized by GMPLS in the GMPLS virtual node configured using the GMPLS integrated controller. Here, FIG. 11 is a diagram illustrating a logical topology recognized by GMPLS in the block configuration of FIG. 10. In FIG. 11, the integrated controller 261 with its slaves, or non-GMPLS nodes 105, is recognized as GMPLS virtual nodes 102-3 and 102-4 because the GMPLS integrated controllers 261-3 and 261-4 are used in FIG. 10. Further, each node and the GMPLS virtual nodes 102-3, 102-4 are recognized as being logically connected by a control channel 270B.

Each node and the GMPLS virtual nodes 102-3, 102-4 are logically connected to the monitoring controller 251 through the monitoring control line 252 and a network 400-3.

The path 800 is recognized as being established in a state through the user node 110-10, GMPLS node 101-9, GMPLS virtual node 102-3, GMPLS node 110-10, and user node 110-12, using the inter-node autonomous control protocol. Further, the state of establishing the partial backup path 801 of FIG. 10 is hidden by the GMPLS virtual node 102-3.

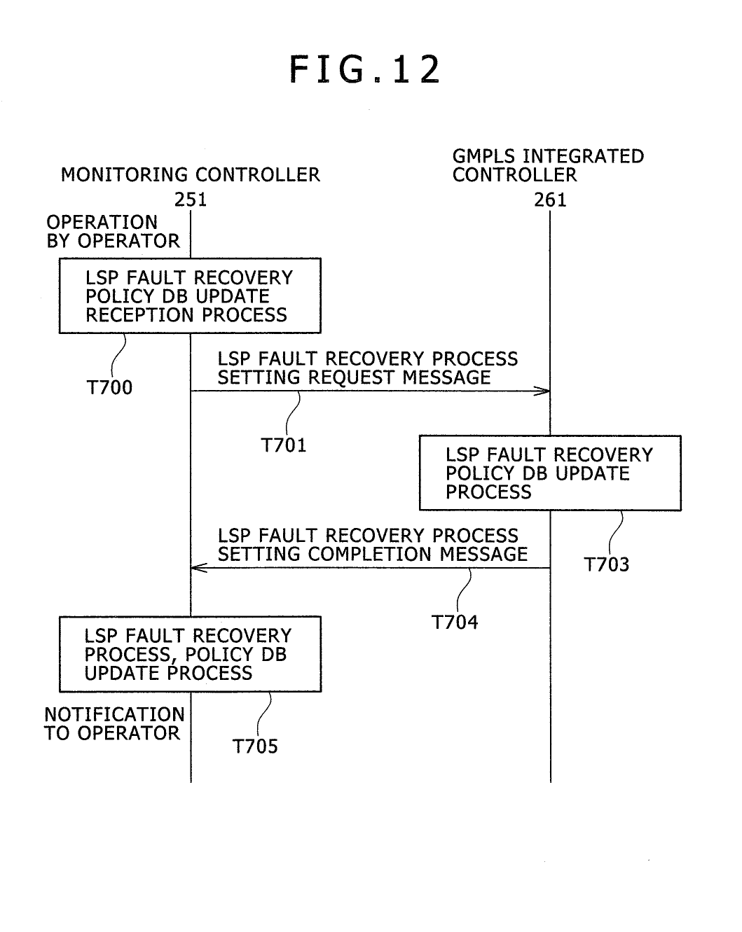

Referring to FIG. 12, a description will be given of a procedure for setting a main signal protection means within the communication network including non-GMPLS nodes, in the GMPLS integrated controller. Here, FIG. 12 is a sequence diagram illustrating a process for updating an LSP fault recovery policy between the monitoring controller and the GMPLS integrated controller. In FIG. 12, in response to an operation by an operator, the monitoring controller 251 performs a process for reception of an LSP fault recovery policy DB update relative to an LSP fault recovery policy DB (DataBase) stored as data in the secondary storage device 390-3 shown in FIG. 5 (T700). Then, according to the received content, the monitoring controller 251 transmits a message for requesting setting of an LSP fault recovery process, to the GMPLS integrated controller 261 (T701). According to the content of the received message for requesting setting of an LSP fault recovery process, the GMPLS integrated controller 261 performs a process for updating an LSP fault recovery policy DB relative to the LSP fault recovery policy DB stored as data in the secondary storage device 390-5 shown in FIG. 9 (T703). Then, the GMPLS integrated controller 261 transmits a message of completion of LSP fault recovery setting, to the monitoring controller 251 (T704). In an event of a failure of the process for updating the LSP fault recovery policy DB (T703), the message of completion of LSP fault recovery process setting may include a message providing information on the failure, such as the cause of the failure. When the monitoring controller 251 receives the message of completion of LSP fault recovery process setting that indicates a success of the updating, the monitoring controller 251 performs a process for updating the LSP fault recovery policy DB (T705). On the other hand, when the message of completion of LSP fault recovery process setting indicates a failure of the process for updating the LSP fault recovery policy DB in the GMPLS integrated controller, the monitoring controller 251 does not perform the process for updating the LSP fault recovery policy DB.

After completion of a series of the processes, the monitoring controller 251 notifies the operator of the process result by a screen display or other means. Incidentally, the series of the processes may be automatically performed by the program 601-3 and the like of the monitoring controller 251, and the notification to the operator may be omitted according to necessary.

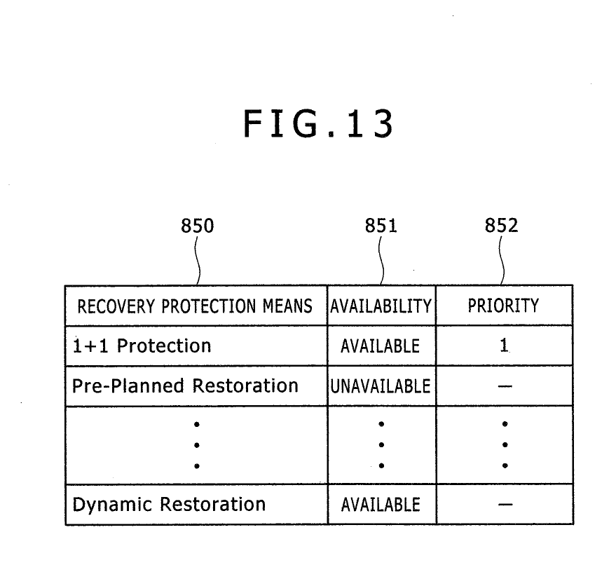

Referring to FIG. 13, a description will be given of the LSP fault recovery policy DB of the main signal protection means within the communication network including the non-GMPLS nodes. Here, FIG. 13 is a diagram illustrating the LSP fault recovery policy DB. In FIG. 13, the LSP fault recovery policy DB is stored in the secondary storage device 390-5 of the GMPLS integrated controller 261. The LSP fault recovery policy DB includes recovery protection means 850, availability 850, and priority 852. The LSP fault recovery policy DB stores, as the recovery protection means 850, 1+1 Protection, Pre-Planned Restoration, Dynamic Restoration, and the like. The availability 851 indicates whether each of the recovery protection means is available. The priority 852 stores the priority of the main signal recovery protection means to be used within the communication network including the non-GMPLS nodes 105 at the time of the LSP establishment. In FIG. 13, when 1+1 Protection is taken as the recovery protection means 850, the availability 851 is “AVAILABLE” indicating that the recovery protection means is available, and the priority 852 is “1” indicating the first priority. Thus, 1+1 Protection is set for the LSP establishment. When Pre-Planned Restoration is taken as the recovery protection means 850, the availability 851 is “UNAVAILABLE” indicating that the recovery protection means is unavailable, and the priority 852 is “-” indicating also unavailable. Thus, Pre-Planned Restoration is not used for the LSP establishment. Further, when Dynamic Restoration is taken as the recovery protection means 850, the availability 851 is “AVAILABLE” indicating that the recovery protection means is available, but the priority 852 is “-” indicating that the recovery protection means is unavailable. Thus, Dynamic Restoration is not used for the LSP establishment. Incidentally, it is possible to select from plural recovery protection means 850 indicated as “AVAILABLE” in the availability 851 according to their priorities in the priority 852, depending on the situation.

Incidentally, the LSP fault recovery policy DB may be prepared for each main signal interface 340-3 of the non-GMPLS node 105 shown in FIG. 8. It is also possible to prepare for each input/output port of the data switch 380-3.

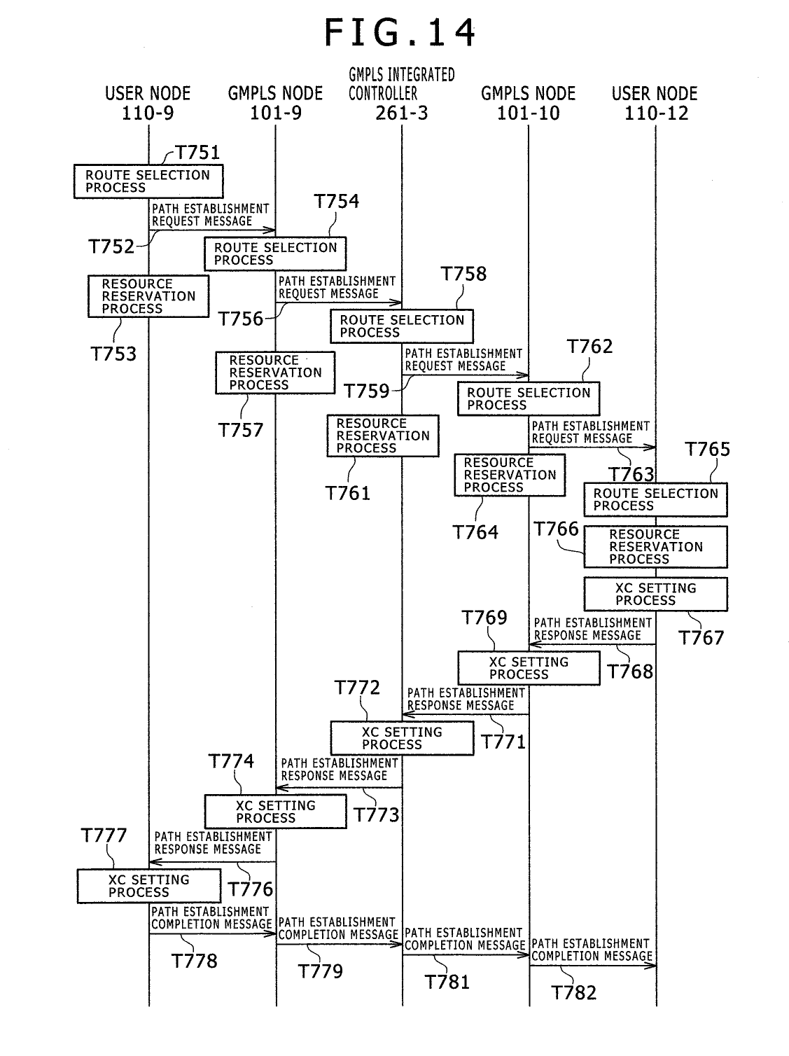

Referring to FIG. 14, a description will be given of a state transition of a path establishment process. Here, FIG. 14 is a sequence diagram of a path establishment process. In FIG. 14, the user node 110-9 receives a path establishment request. Then, the user node 110-9 selects a route by a route selection process (T751), transmits a path establishment request message to the GMPLS node 101-9 (T752), and performs a resource reservation process (T753). Upon receiving the path establishment request message, the GMPLS node 101-9 performs a route selection process (T754), transmits a path establishment request message to the GMPLS integrated controller 261-3 (T756), and performs a resource reservation process (T757). Upon receiving the path establishment request message, the GMPLS integrated controller 261-3,performs a route selection process within the communication network including the non-GMPLS nodes 105-7 to 105-9, as well as a route selection process for GMPLS-based path establishment (T758). Then, the GMPLS integrated controller 261-3 transmits a path establishment request message to the GMPLS node 101-10 (T759), and performs a resource reservation process to reserve resources within the communication network including the non-GMPLS nodes 105-7 to 105-9 (T761).

Upon receiving the path establishment request message, the GMPLS node 101-10 performs a route selection process (T762), and transmits a path establishment request message to the user node 110-12 (T763). Then, the GMPLS node 101-10 performs a resource reservation process (T764). Upon receiving the path establishment request message, the user node 110-12 performs a route selection process (T765), and performs a resource reservation process (T766). Then, the user node 110-12 performs a cross-connect setting process (hereinafter referred to as XC setting process) (T767), and transmits a path establishment response message to the GMPLS node 101-10 (T768).

Upon receiving the path establishment response message, the GMPLS node 101-10 performs a cross-connect setting by XC setting process (T769), and transmits a path establishment response message to the GMPLS integrated controller 261-3 (T771). Upon receiving the path establishment response message, the GMPLS integrated controller 261-3 performs a cross-connect setting by XC setting process within the communication network including the non-GMPLS nodes 105-7 to 105-9 (T772), and transmits a path establishment response message to the GMPLS node 101-9 (T773). Upon receiving the path establishment response message, the GMPLS node 101-9 performs a cross-connect setting by XC setting process (T774), and transmits a path establishment response message to the user node 110-9 (T776).

Upon receiving the path establishment response message, the user node 110-9 performs a cross-connect setting by XC setting process (T777), and transmits a path establishment completion message to the GMPLS node 101-9 (T778). The GMPLS node 101-9 receives the path establishment completion message, and transmits a path establishment completion message to the GMPLS integrated controller 261-3 (T779). The GMPLS integrated controller 261-3 receives the path establishment completion message, and transmits a path establishment completion message to the GMPLS node 101-10 (T781). The GMPLS node 101-10 receives the path establishment completion message, and transmits a path establishment completion message to the user node 110-12 (T782).

Incidentally, in a system that recognizes that the path establishment is completed when a predetermined time has passed after the XC setting processes (T767, T769, T772, T774, T777) are performed in the respective nodes, the path establishment messages (T778 to T782) can be omitted. Further, the resource reservation process (T766) in the user node 110-12 may be omitted according to necessity, and may be replaced with the XC setting process (T767). Still further, the procedure for setting the GMPLS-based fault recovery protection means may be added according to necessity.

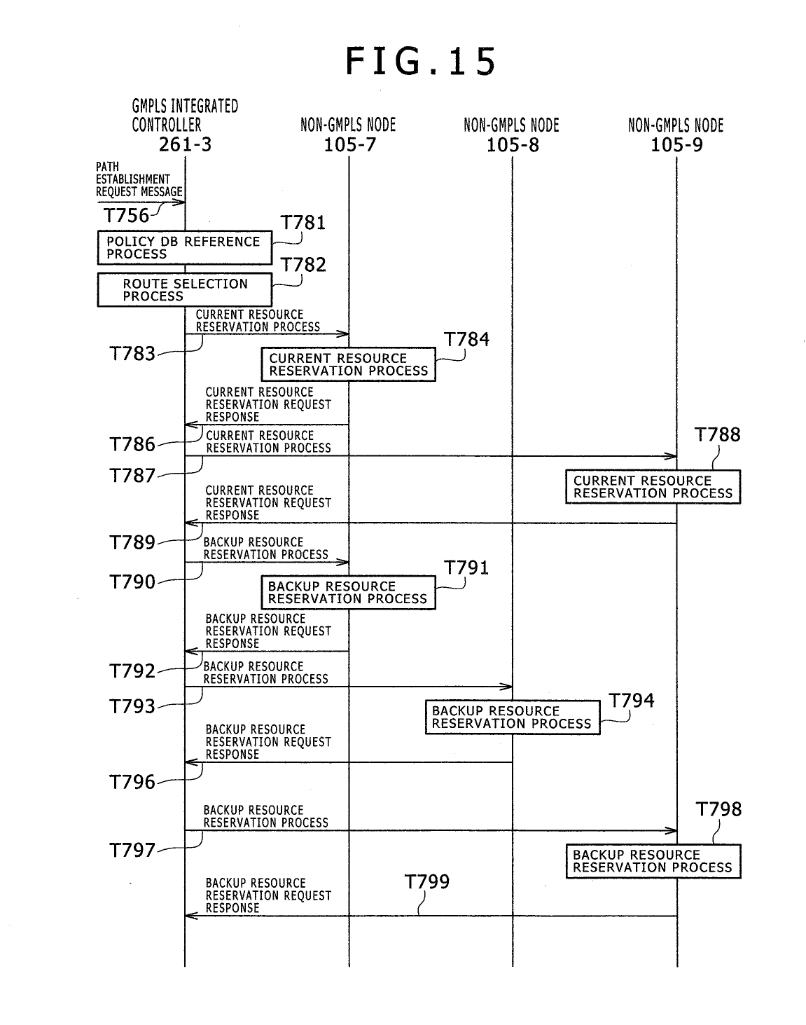

Referring to FIG. 15, a description will be given of a resource reservation process within the GMPLS virtual node. Here, FIG. 15 is a sequence diagram illustrating a resource reservation process of the GMPLS virtual node. In FIG. 15, when the GMPLS integrated controller 261-3 receives the path establishment request message in T756 of FIG. 14, the GMPLS integrated controller 261-3 performs a policy DB reference process (T781) to determine the main signal protection means, by referring to the LSP fault recover policy DB of the main signal protection means shown in FIG. 13. Then, the GMPLS integrated controller 261-3 selects a route of the main signal in a route selection process (T782). Here, the description will be given assuming that 1+1 Protection is selected by the policy DB reference process. More specifically, it is assumed that the route between the non-GMPLS nodes 105-7 and 105-9 is selected for the current system, and that the route between the non-GMPLS nodes 105-7, 105-8, and 105-9 is selected for the backup system.

In this case, the GMPLS integrated controller 261-3 transmits a current resource reservation request to the non-GMPLS node 105-7 (T783). Upon receiving the current resource reservation request, the non-GMPLS node 105-7 performs a current resource reservation process (T784), and returns a response for the current resource reservation request to the GMPLS integrated controller 261-3 (T786). The GMPLS integrated controller 261-3 also transmits a current resource reservation request to the non-GMPLS node 105-9 (T787). Upon receiving the current resource reservation request, the non-GMPLS node 105-9 performs a current resource reservation process (T788), and returns a response for the current resource reservation request to the GMPLS integrated controller 261-3 (T789). Next, the GMPLS integrated controller 261-3 transmits a backup resource reservation request to the non-GMPLS node 105-7 (T790).

Upon receiving the backup resource reservation request, the non-GMPLS node 105-7 performs a backup resource reservation process (T791), and returns a response for the backup resource reservation request to the GMPLS integrated controller 261-3 (T792). Further, the GMPLS integrated controller 261-3 transmits a backup resource reservation request to the non-GMPLS node 105-8 (T793). Upon receiving the backup resource reservation request, the non-GMPLS node 105-8 performs a backup resource reservation process (T794), and returns a response for the backup resource reservation request to the GMPLS integrated controller 261-3 (T796). The GMPLS integrated controller 261-3 also transmits a backup resource reservation request to the non-GMPLS node 105-9 (T797). Upon receiving the backup resource reservation request, the non-GMPLS node 105-9 performs a backup resource reservation process (T798), and returns a response for the backup resource reservation request to the GMPLS integrated controller 261-3 (T799).

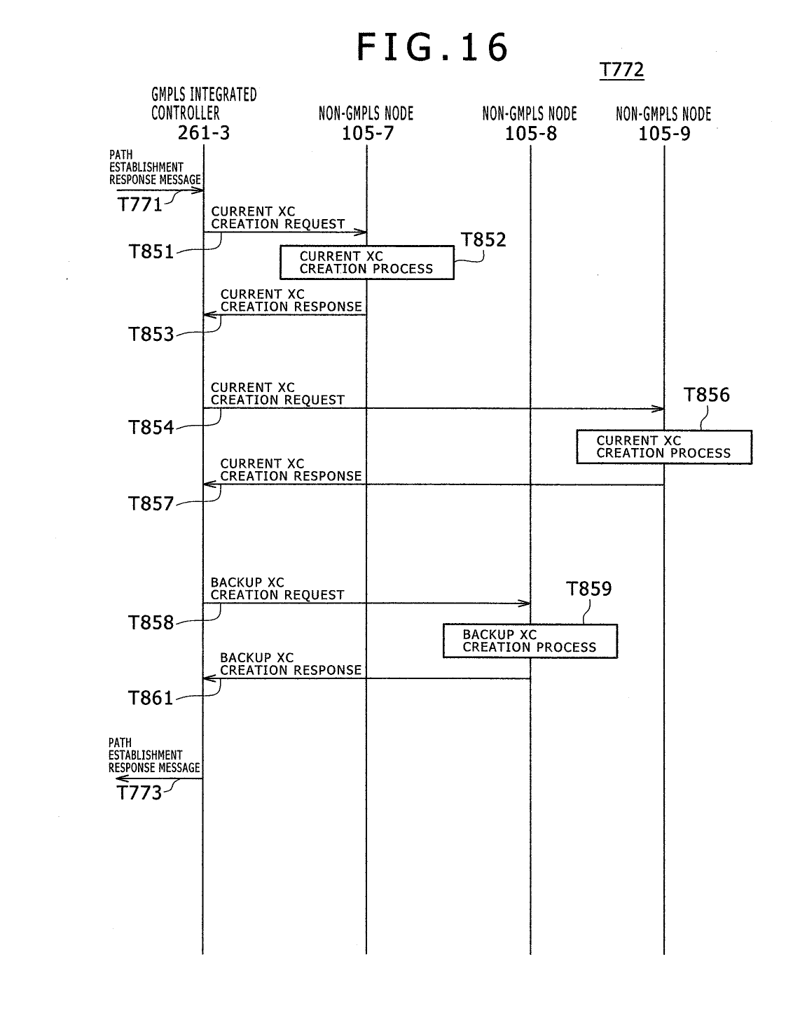

Referring to FIG. 16, a description will be given of XC setting process within the GMPLS virtual node. Here, FIG. 16 is a sequence diagram illustrating XC setting process of the GMPLS virtual node. In FIG. 16, when the GMPLS integrated controller 261-3 receives the path establishment response message in T771 of FIG. 14, the GMPLS integrated controller 261-3 performs XC creation process according to the route determined by the procedure shown in FIG. 16. The GMPLS integrated controller 261-3 transmits a current XC creation request to the non-GMPLS node 105-7 (T851). Upon receiving the current XC creation request, the non-GMPLS node 105-7 performs a cross-connect setting by a current XC creation process (T852). Then, the non-GMPLS node 105-7 transmits a current XC creation response to the GMPLS integrated controller 261-3 (T853). The GMPLS integrated controller 261-3 also transmits a current XC creation request to the non-GMPLS node 105-9 (T854). Upon receiving the current XC creation request, the non-GMPLS node 105-9 performs a cross-connect setting by a current XC creation process (T856). Then, the non-GMPLS node 105-9 transmits a current XC creation response to the GMPLS integrated controller 261-3 (T857). Further, the GMPLS integrated controller 261-3 transmits a backup XC creation request to the non-GMPLS node 105-8 (T858). Upon receiving the backup XC creation request, the non-GMPLS node 105-8 performs a cross-connect setting by a backup XC creation process (T859). Then, the non-GMPLS node 105-8 transmits a backup XC creation response to the GMPLS integrated controller 261-3 (T861).

Upon completion of a series of the processes, the GMPLS integrated controller 261-3 transmits a path establishment response message (T773). Incidentally, when Restoration is selected for the main signal protection means within the GMPLS virtual node, the backup generation processes (T858 to T861) to the non-GMPLS node 105-8 may be omitted.

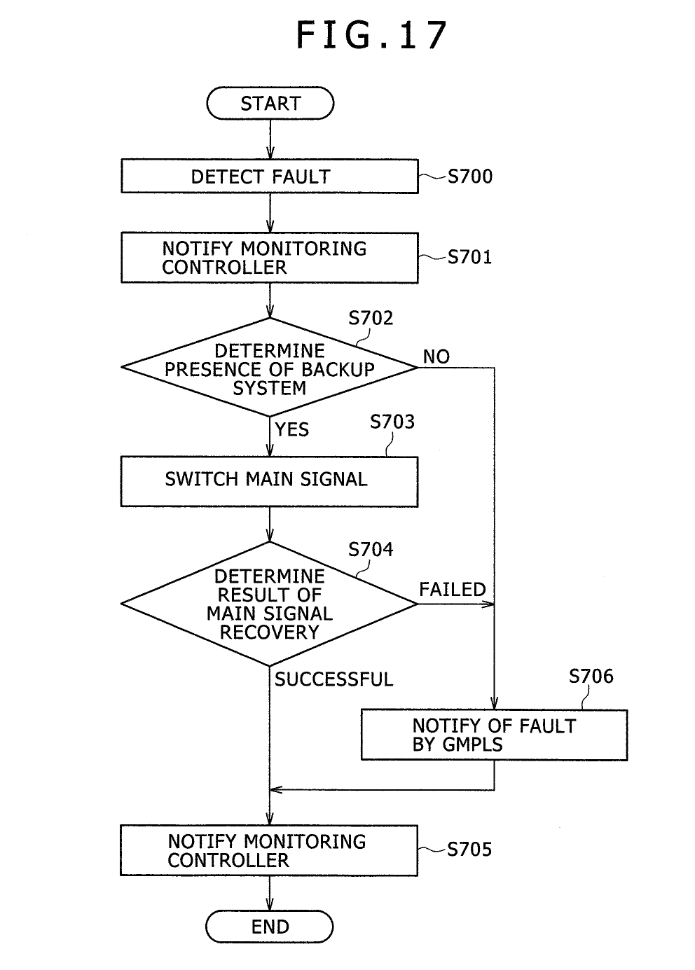

Referring to FIG. 17, a description will be given of a main signal protection process within the GMPLS virtual node. Here, FIG. 17 is a flowchart illustrating a main signal protection process within the GMPLS virtual node. In FIG. 17, when the non-GMPLS node 105-7 or 105-9 of the virtual GMPLS node 102-3 detects a fault (S700), the GMPLS integrated controller 261-3 performs a notification process to the monitoring controller 251 (S701). Then, the GMPLS integrated controller 261-3 performs a process to determine whether a main signal protection means is present (S702). When it is determined that a backup system is present by a backup system presence determination process, the non-GMPLS nodes 105-7 and 105-9 perform fault recovery by a main signal switching process (S703). Next, the GMPLS integrated controller 261-3 confirms that the main signal is normally recovered (S704). When it is determined that the main signal is successfully recovered by a main signal recovery determination process, the GMPLS integrated controller 261-3 notifies the monitoring controller 251 of a switching result (S705), and ends the process.

When it is determined that there is no main signal recovery means by the backup system determination process in Step 702, or when it is determined that the main signal recovery was failed by the main signal recovery determination process in Step 704, the GMPLS integrated controller 261-3 notifies of the occurrence of fault by the GMPLS mechanism (S706), and moves to Step 705. In this way, when the fault recovery is successful within the GMPLS virtual node 102, the main signal can be protected without activating the GMPLS-based fault recovery process. On the other hand, when there is no fault recovery means within the GMPLS virtual node 102 or the main signal recovery is failed, it is possible to perform GMPLS-based fault recovery process by activating the GMPLS-based fault recovery process.

FIGS. 18 to 28 are diagrams illustrating a cross-connect setting state database stored in the non-GMPLS node 105. The cross-connect setting state database serves as a database relating to the connection state through the main signal interface 340-3 and data switch 380-3 of the non-GMPLS node 105 shown in FIG. 8. The cross-connect setting state database is stored in the secondary storage device 390-4 of the non-GMPLS node 105 shown in FIG. 8, as well as in the secondary storage device 390-5 of the GMPLS integrated controller 261 shown in FIG. 9. In the cross-connect setting state database, a port number 900 is assigned to each main signal interface 340-3 to uniquely identify the main signal interface. The information relating to the wavelength used in the main signal interface 340-3 is stored as a wavelength 910. The type of the data signal is stored as a type 920. The port number of the main signal interface 340-3 to be connected by the data switch 380-3 is stored as a destination port number 930. The usage state of each port is stored as a state 940. Incidentally, the cross-connect setting state database may store data other than those described above according to necessity.

FIG. 18 is a diagram illustrating the cross-connect setting state database in the initial state in the non-GMPLS node 105-7. In the initial state of the non-GMPLS node 105-7, the cross-connect setting is not established by the data switch 380-3, so that “-” indicating that the ports are not used is stored as the destination port number 930-1. Also, the value “UNUSED” is stored as the state 940-1 for each port due to the initial state.

FIG. 19 is a diagram illustrating the cross-connect setting state database, after the current resource reservation process and the backup resource reservation process are performed in the non-GMPLS node 105-7. When the current resource reservation process is performed (T784), “1” and “20” of the port number 900-2 are reserved as current ports, and each corresponding value of the state 940-2 is changed to “RESERVED” indicating that the each port is reserved. Further, when the backup resource process is performed (T791), “24” of the port number 900-2 is reserved for backup, and the value of the state 940-2 is changed to “RESERVED” indicating that the port is reserved.

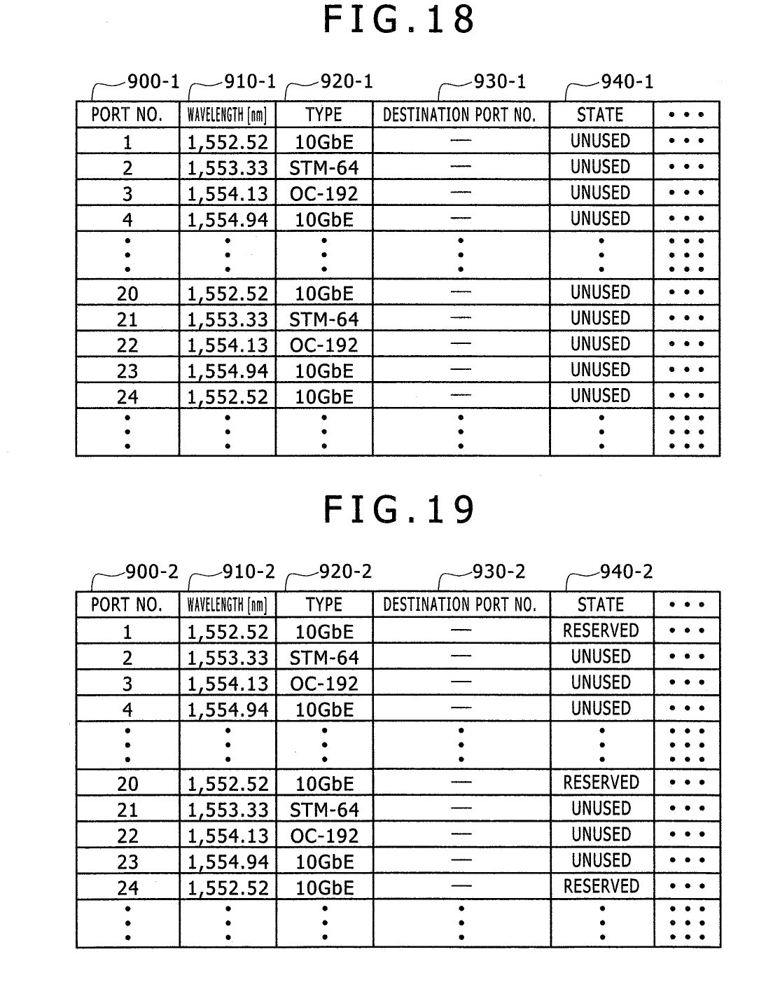

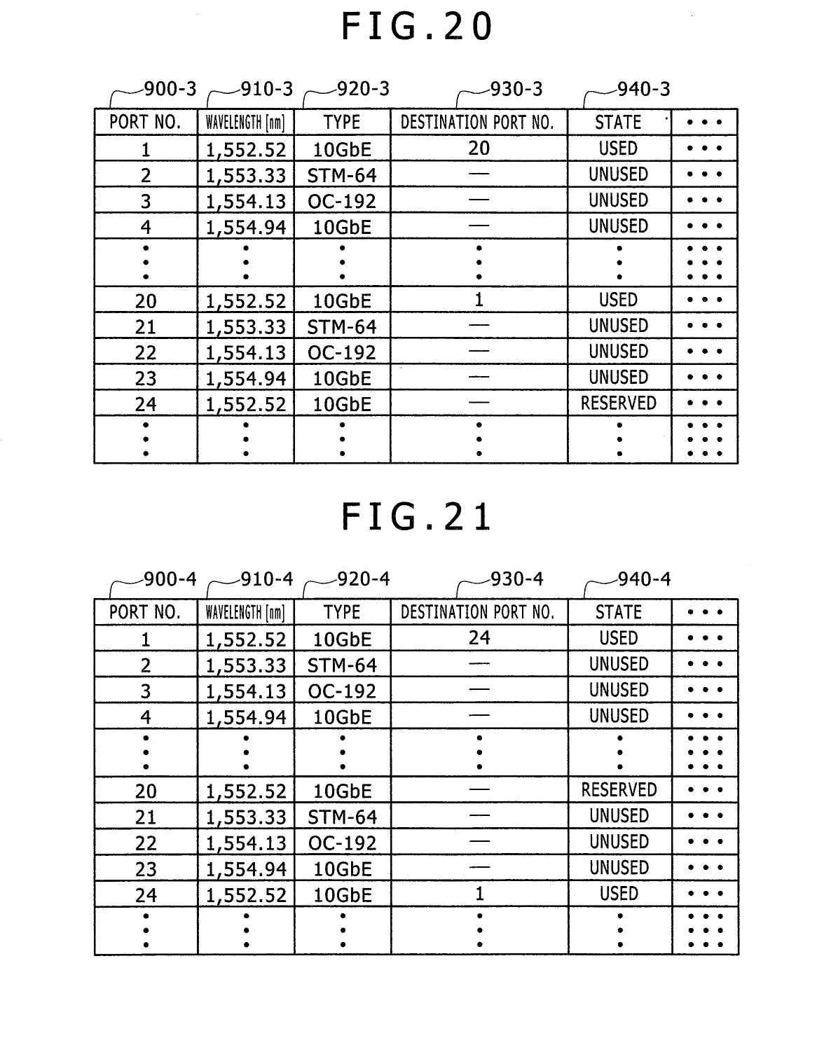

FIG. 20 is a diagram illustrating the cross-connect setting state database after the current XC creation process is performed in the non-GMPLS node 105-7. In the current XC creation process in FIG. 16 (T852), “1” and “20” of the port number 900-3, which are reserved as current ports, are cross-connected by the data switch 380-3. In this way, the cross-connections necessary for establishment of the path 800 are created. Further, the values of the state 940-3 corresponding to “1” and “20” of the port number 900-3 are changed to “USED” indicating that the ports are used. Further, as the destination port number 930-3, “20” and “1” are stored for “1” and “20” of the port number 900-3, respectively.

FIG. 21 is a diagram illustrating the cross-connect setting state database after the main signal switching process is performed in the non-GMPLS node 105-7. The destination of “1” of the port number 900-4 is changed from “20” to “24” by the switching process of the data switch 380-3. Thus, the connection is switched to the partial backup path 801. Because of the process, the value of the destination port 930-4 corresponding to “1” of the port number 900-4 is changed to “24”, and the value of the state 940-4 is changed to “USED”. Further, the value of the destination port number 930-4 corresponding to “20” of the port number 900-4, which has been in current use, is changed to “-” indicating that the port is not used. Then, the value of the state 940-4 is changed to “RESERVED” indicating that the port is reserved.

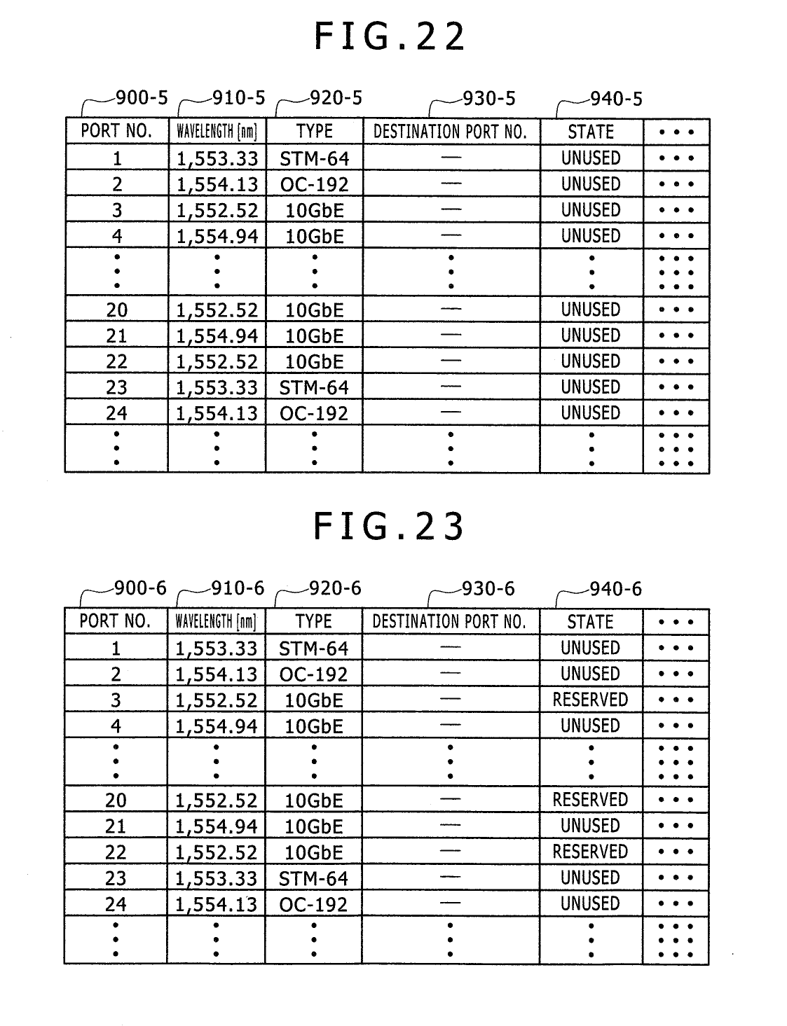

FIG. 22 is a diagram illustrating the cross-connect setting state database in the initial state in the non-GMPLS node 105-9. In the initial state of the non-GMPLS node 105-9, the cross-connect setting is not established by the data switch 380-3, so that “-” indicating that the ports are not used, is stored as the destination port number 930-5. Also, the value “UNUSED” is stored as the state 940-5 for each port due to the initial state.

FIG. 23 is a diagram illustrating the cross-connect setting state database, after the current resource reservation process and the backup resource reservation process in FIG. 15 are performed in the non-GMPLS node 105-9. When the current resource reservation process is performed, “3” and “22” of the port number 900-6 are reserved as current ports, and each corresponding value of the state 940-6 is changed to “RESERVED” indicating that the each port is reserved. When the backup resource reservation process is performed (T798), “20” of the port number 900-6 is reserved for backup, and the value of the state 940-6 is changed to “RESERVED” indicating that the port is reserved.

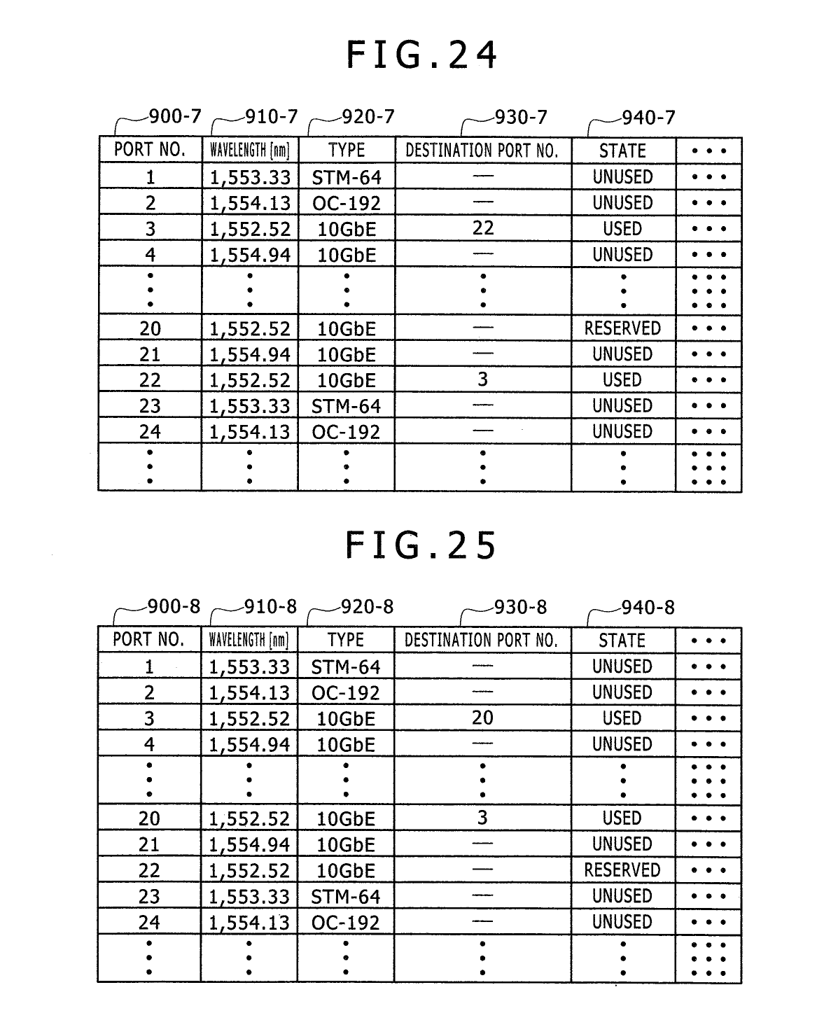

FIG. 24 is a diagram illustrating the cross-connect setting state database after the current XC creation process is performed in the non-GMPLS node 105-9. In the current XC creation process in FIG. 16 (T856), “3” and “22” of the port number 900-7, which are reserved as current ports, are cross-connected by the data switch. In this way, the cross-connections necessary for establishment of the path 800 are created. Because of the process, the values of the state 940-7 corresponding to “3” and “22” of the port number 900-7 are changed to “USED” indicating that the ports are used. Further, as the destination port number 930-7, “22” and “3” are stored for “3” and “22” in port number 900-7, respectively.

FIG. 25 is a diagram illustrating the cross-connect setting state database after the main signal switching process is performed in the non-GMPLS node 105-9. The destination of “3” of the port number 900-8 is changed from “22” to “20” by the switching process of the data switch 380-3. Thus, the connection is switched to the partial backup path 801. Because of the process, the value of the destination port 930-8 corresponding to “3” of the port number 900-8 is changed to “20”. Further, the value of the destination port 930-8 corresponding to “20” of the port number 900-8 is changed to “3”. Then, each corresponding value of the state 940-8 is changed to “USED”. Further, the value of the destination port number 930-8 corresponding to “22” of the port number 900-8, which has been in current use, is changed to “-” indicating that the port is not used, and the state 940-8 is changed to “RESERVED” indicating that the port is reserved.

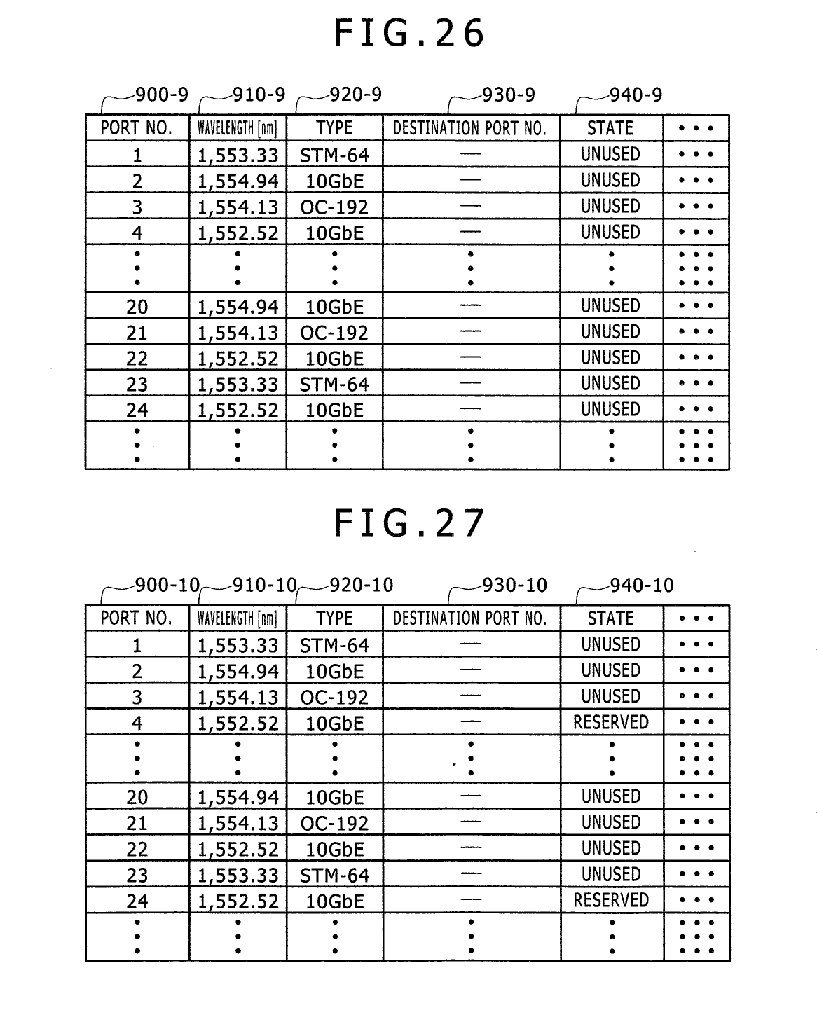

FIG. 26 is a diagram illustrating the cross-connect setting state database in the initial state in the non-GMPLS node 105-8. In the initial state of the non-GMPLS node 105-8, the cross-connect setting is not established by the data switch 380-3, so that “-” indicating that the ports are not used is stored for the destination port number 930-9. Also, the value “Unused” is stored for the state 940-9 for each port due to the initial state.

FIG. 27 is a diagram illustrating the cross-connect setting state database after the backup resource reservation process is performed in the non-GMPLS node 105-8. When the backup resource reservation process is performed (T794), “4” and “24” of the port number 900-10 are reserved for backup, and each corresponding value of the state 940-10 is changed to “RESERVED” indicating that the each port is reserved.

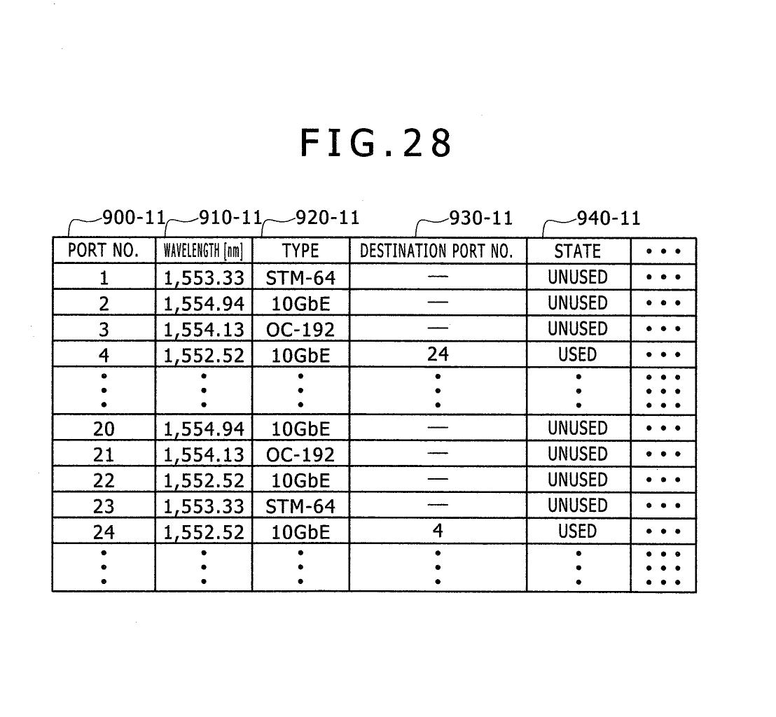

FIG. 28 is a diagram illustrating the cross-connect setting state database after the backup XC creation process is performed in the non-GMPLS node 105-8. In the backup XC creation process in FIG. 16 (T859), “4” and “24” of the port number 900-11 are cross-connected by the data switch 380-3. In this way, the cross-connections necessary for establishment of the partial backup path 801 are created. Because of the process, the values of the state 940-11 corresponding to “4” and “24” of the port number 900-11 are changed to “USED” indicating that the ports are used. Further, as destination port number 930-11, “24” and “4” are stored for “4” and “24” of the port number 900-11, respectively. At the time the main signal switching process S703 is performed in FIG. 17, the necessary cross-connections have been created in the non-GMPLS node 105-8 by this process. Thus, it is possible to establish the partial backup path 801 by switching to the backup system in the non-GMPLS nodes 105-7 and 105-9.

According to the present invention, it is possible to effectively perform fault recovery in a communication network using an inter-node autonomous control protocol, by controlling a communication network including plural nodes without having the inter-node autonomous control protocol, as a virtual single node by an integrated controller using the inter-node autonomous control protocol.

What is claimed is:

1. A node controller to which a plurality of first nodes without having an inter-node autonomous control protocol and a second node having an autonomous control protocol, are connected,
wherein said node controller represents the plurality of first nodes to exchange the autonomous control protocol with the second node.

2. The node controller according to claim 1,
wherein said node controller recognizes that a path fault occurring between the plurality of first nodes is autonomously recovered between the first nodes.

3. The node controller according to claim 1,
wherein said node controller is further connected to a monitoring controller, notifying the monitoring controller of an occurrence of a path fault between the plurality of first nodes as well as of a recovery from the path fault.

4. A node system comprising:
a plurality of first nodes without having an inter-node autonomous control protocol;
a second node having an autonomous control protocol; and
a node controller to which the plurality of first nodes and the second node are connected,
wherein, when a path fault occurs between the plurality of first nodes, a first fault recovery is attempted between the first nodes, and
when said first fault recovery is not successful, the node controller attempts a second fault recovery with the second node using the autonomous control protocol.

5. A node system comprising:
a plurality of first nodes without having an inter-node autonomous control protocol;
a second node having an autonomous control protocol; and
a node controller to which the plurality of first nodes and the second node are connected, and
said node controller controls the path connection between the plurality of first nodes.

6. The node system according to claim 4,
wherein said node controller stores the cross-connect setting state of each of the plurality of first nodes.

7. The node system according to claim 5,
wherein said node controller stores the cross-connect setting state of each of the plurality of first nodes.
